(19) United States
(12) Patent Application Publication
(10) Pub. No.: US 2007/0079635 A1
(43) Pub. Date: Apr. 12, 2007

(54) Apparatus and method for preparing optical fiber preform having desired cone shape

(75) Inventors: Parag Kulkarni, Aurangabad (IN); Sham Nagarkar, Aurangabad (IN)

Correspondence Address: JAMES RAY & ASSOCIATES, 2640 Pitcairn Road, Monroeville, PA, 15146, US

(73) Assignee: STERLITE OPTICAL TECHNOLOGIES LTD.

(21) Appl. No.: 11/636,005

(22) Filed: Dec. 8, 2006

(30) Foreign Application Priority Data
Oct. 6, 2006 (IN) 1656/MUM/2006

(51) Int. Cl. C03B 37/16; C03B 37/018

(52) U.S. Cl. 65/433; 65/414; 65/421

(57) ABSTRACT

An apparatus for preparing a preform cone having desired shape and dimensions, including diameter is provided, wherein said apparatus comprises a box type structure having a coupling means suitably provided on the inner side of upper face for holding one end of the core rod of the soot preform which is required to be subjected to step of cone preparation; a grinding or cutting means suitably provided on the inner side of one of the faces of the box type structure for grinding or cutting the preform end to produce preform cone of desired shape and dimensions including diameter; a suction means suitably provided on inner side of one of the faces of the box type structure for immediate removal of soot particles produced during grinding or cutting of the preform end to produce the preform cone of desired shape and dimensions; and an adjustable rotating means suitably connectable to grinding or cutting means to have simultaneous control of rotation speed and position of the grinding or cutting means with respect to preform end wherein the preform cone is being prepared. A process for preparation of preform cone of desired shape and dimensions including diameter, and soot preform prepared by said process and optical fiber prepared from said soot preform are also provided.

### FIELD OF THE INVENTION

The present invention relates to an apparatus and method for preparing optical fiber preform having desired cone shape. Particularly, it relates to an apparatus and method for preparing a cone of the preform so as to make it suitable for drawing the fiber and at the same time saving wastage of ends of the preform, and process time and process energy to make the overall process highly convenient and economical. The present invention also relates to optical fiber preform produced while employing apparatus and method of the present invention, and to the fiber produced from such preform.

### BACKGROUND OF THE INVENTION

Optical fibers are inherently versatile as a transmission medium for all forms of information, be it voice, video or data. The optical fibers are drawn from an optical fiber preform. The optical fiber of predetermined dimension is drawn from the optical fiber preform by subjecting one end of the preform to a high temperature, for example above 2000° C. Under such a high temperature, the tip of the preform softens, from which a thin fiber of desired dimension is drawn. The different methods employed in manufacture of these preforms are described in the literature.

The optical fiber preform can be manufactured by different methods of chemical vapour deposition (CVD). The optical fiber preform manufacturing process primarily involves a step of preparing the core rod comprising core of the fiber and part of clad which may be followed by over-cladding. The core rod can be prepared by methods known in the art, such as modified chemical vapour deposition (MCVD), plasma chemical vapour deposition (PCVD), Atmospheric chemical vapour deposition (ACVD), vapour axial deposition (VAD) etc. The over-cladding of the core rod can also be carried out by various methods, such as glass tube jacketing, ACVD soot over-cladding, VAD soot over-cladding, plasma over-cladding etc. The optical fiber preform can be manufactured by any combination of the core rod manufacturing methods and the over-cladding preparation methods.

The soot over cladding method has been disclosed in co-pending Indian patent application no. 1073/MUM/2005 (herein after IPA1073) a reference to which is drawn here. In accordance with the one of the preferred embodiments of the method disclosed in IPA1073, the opposite ends of the core rod are heated by heating means provided towards opposite ends of the core rod to achieve a predetermined temperature, and this step is continued while maintaining the predetermined temperature of the opposite ends of the rod till a soot porous body of a minimum diameter is formed, and this step of heating the opposite ends is further continued while increasing the predetermined temperature of the opposite ends of the rod and while depositing the soot particles thereon to achieve a particular temperature and an intermediate diameter of the soot porous body, which is further continued while maintaining the particular temperature of the opposite ends of the rod till a soot porous body of a desired diameter is formed.

The method disclosed in IPA1073 has been found suitable for achieving desired diameter and for avoiding problems of physical defects such as cracks, breakages, damages, bends, splits or slippages at the opposite ends of the soot porous body meaning thereby this method results in production of the preform having desired cone shape at the opposite ends thereof. However, the IPA1073 method does not address the problems encountered during the process step of cone preparation just before the step of fiber draw. Even in accordance with IPA1073, one need to perform the step of heating the preform end to a very high temperature of about 2000° C. to finally have a cone of desired shape, which is suitable for start of fiber draw step to finally draw the fiber without having breakage and also to reduce the loss of fiber length during start of fiber draw step. Accordingly, the IPA1073 also suffers from the essential requirement of heating the preform end to finally achieve the desired cone shape just before the fiber draw step to finally draw the fiber.

Accordingly, in accordance with methods as known in the prior art, the fiber draw step is performed while heating the preform end to a very high temperature of about 2000° C. However, desired shape of cone formation in drawing stage before the fiber draw step consumes more than one hour for each preform, which will reduce the productivity of optical fiber.

In order to eliminate the cone formation step at drawing stage and to increase the productivity, the cone formation is prepared separately from the drawing furnace by heating means as known in the prior art.

The main problem of preparation of cone having desired shape which is suitable for start of fiber draw step at one of the opposite ends of the preform by heating the respective opposite end is that the preform bottom end needs to be loaded in a specially built furnace to heat the preform to a very high temperature of the order of about 2000° C. Further, if the cone is prepared at one of the preform ends by step of heating and such preform is required to be stored before drawing the fiber, then the preform is required to be cooled to a temperature suitable for safe handling and storage, which can only be achieved by loading the preform from the step of heating in a specially built containers or vessels comprising proper cooling systems for the step of cooling.

Therefore, the known methods of preparing the cone of desired shape by heating not only suffer from the drawbacks of requiring a step of heating the preform in a specially built furnace to a very high temperature of the order of about 2000° C. and requiring specially built containers or vessels comprising proper cooling systems for loading of preform for the step of cooling, that is also suffer from the problem of requiring additional process step of cooling the preform after preparation of cone of desired shape if the preform has to be stored for fiber draw at a later stage.

Further, it has been observed that the cooling of the preform has to be performed very carefully in a highly controlled manner, because non-uniform cooling or immediate cooling or abrupt cooling has been shown to cause physical defects and stress formation in the preform cone. It has been observed that physical defects and stress in the preform cone leads to transmission loss in the resulting optical fiber or distort other optical parameters, for example, polarization mode dispersion, cutoff wavelength etc. Therefore, the step of cooling the cone prepared by step of heating additionally also requires specially designed cooling means suitable for performing the controlled cooling of the preform so as to avoid occurrence of physical defects, stress formation etc. in the cone prepared.

Therefore, the known processes for preparation of cone of desired shape just before the fiber draw step are not only highly time consuming and power or energy consuming, but are also highly complicated and uneconomical for commercial applications, because of requirement of specially built furnaces with specially designed heating means for example burners of hydroxyl flame, heating by graphite resistance or induction furnace, or by plasma heating means, power full heating means of laser, like carbon dioxide laser etc. for heating the preform end and requirement of specially designed containers or vessels comprising proper cooling systems for loading of preform to have cooling in highly controlled manner.

The hydroxyl flame which is commonly used for cone preparation has been observed to result in increase of hydroxyl contents of the preform, which in-turn has been observed to result in increased transmission loss, particularly at about 1380 nm wavelength band meaning thereby the preform is not suitable for CDWM (16 Channels) applications.

Further, the use of commonly used hydroxyl flame also results in wastage of the glass during the cone cutting process.

The heating by graphite resistance or induction furnace has been observed to cause graphite oxidation which results in formation of oxidation products, for example ash, graphite particles etc. which adheres to the preform surface, and such contamination of the preform with unwanted particles results in production of a preform which will produce a fiber having transmission loss and poor strength.

Further drawback of the preform cone preparation by heating step is that the preform has to be placed inside the furnace, the gap between the furnace and preform needs to be sealed properly, otherwise the graphite heating material will get oxidized thus particles will adhere to the outer surface of preform and/or cone.

The lasers, such as carbon dioxide lasers, which are clean heat source to operate, also suffer from the drawback of consuming high power to generate required high temperature meaning thereby there is increase in overall production cost. Further, with use of lasers, one cannot produce preform cones of higher diameter.

Further, it has also been observed that large amount of thermal induced stress in the preform cone area may shatter the preform to pieces.

It has been further observed that whatever, one may do to have controlled heating and controlled cooling, even then by the known methods of preparation of the preform cone by step of heating followed by step of cooling, one cannot have precisely controlled cone of desired shape and dimensions which can be suitable for start of fiber draw without wastage of preform meaning thereby one cannot have preform cone of predetermined shape and dimensions including desired diameter.

### NEED OF THE INVENTION

Therefore, there is a need to have a method and an apparatus for preparing desired cone shape of the preform by avoiding step of heating the preform end in order to overcome all associated disadvantages, drawbacks and limitations of the step of heating the preform end, and hence of cooling the preform end after preparation of preform cone.

### OBJECTS OF THE INVENTION

Accordingly, the main object of the present invention is to provide a method and an apparatus for preparing desired cone shape of the preform, wherein no step of heating of preform end is performed meaning thereby which overcomes all associated disadvantages, drawbacks and limitations of the step of heating the preform end as described herein, and hence of cooling the preform end after preparation of preform cone, and which also addresses the problems encountered during the process step of cone preparation just before the process step of fiber draw and which is also suitable to produce preform cone having precisely controlled cone of desired shape and dimensions, including desired diameter suitable for start of fiber draw without wastage of preform.

One particular object of the present invention is to provide a method and an apparatus for preparing desired cone shape of the preform, wherein step of heating the preform end to a very high temperature of about 2000° C. is totally avoided/eliminated to finally have a preform cone of desired shape, which is not only suitable for start of fiber draw step to finally draw the fiber but also avoids formation of any defects in the preform cone to avoid possibility of breakage meaning thereby reduces the loss of fiber length during start of fiber draw step results in exorbitant power and energy savings.

Another particular object of the present invention is to provide a method and an apparatus for preparing desired cone shape of the preform, wherein the preform cone having any desired shape and dimensions, including higher diameter can be prepared with ease and convenience and within a short span of time meaning thereby making the overall process not only controlled and convenient, but also highly time saving, and hence, making the overall process highly productive and economical for commercial applications.

Still another particular object of the present invention is to provide a method and an apparatus for preparing desired cone shape of the preform, wherein the preform is not required to be loaded in any complicated and sophisticated and expensive and specially built containers or vessels with proper cooling systems thereby making the overall process further economical for commercial purposes.

Yet another particular object of the present invention is to provide a method and an apparatus for preparing desired cone shape of the preform, wherein the step of cooling of the prepared preform cone to a suitable temperature suitable for safe handling of the prepared preform cone is totally avoided, meaning thereby the object is to have a method and apparatus for preparing preform cone wherein possibility of non-uniform cooling or immediate cooling or abrupt cooling is totally avoided, and hence, possibility of formation of physical defects and stress in the preform cone is totally avoided which otherwise would have formed if the prepared preform cone is non-uniformly cooled or immediately cooled or abruptly cooled.

Further, particular object of the present invention is to provide a method and an apparatus for preparing desired cone shape of the preform, wherein the preform produced will be suitable to produce a fiber not only having reduced transmission loss, but also having desired other optical parameters, for example, desired polarization mode dispersion, cutoff wavelength etc.

Still further particular object of the present invention is to provide a method and an apparatus for preparing desired cone shape of the preform, wherein the requirement of specially designed heating means, for example hydroxy flame burners, graphite resistance or induction furnace, plasma heating means, power full laser heating means for heating the preform end is totally avoided, and therefore, the disadvantages associated with such specially designed heating means are totally avoided.

Yet further particular object of the present invention is to provide a method and an apparatus for preparing desired cone shape of the preform, wherein the possibility of increase of hydroxyl contents of the preform during the step of cone preparation is avoided, and hence a preform produced will have reduced transmission loss, particularly at about 1380 nm wavelength band and accordingly the preform produced will be suitable for CDWM (16 Channels) applications.

This is further particular object of the present invention to provide a method and an apparatus for preparing desired cone shape of the preform, wherein the possibility of contamination of preform produced with oxidation products, for example ash, graphite particles etc. is avoided by avoiding the use of graphite resistance or induction furnace, thereby possibility of transmission loss and poor strength of the preform produced is avoided.

This is another particular object of the present invention to provide a method and an apparatus for preparing desired cone shape of the preform, wherein by avoiding use of lasers, such as carbon dioxide lasers for preparation of preform cone losses on account of consumption of high power required to generate required high temperature is avoided meaning thereby the overall production cost is reduced, and possibility of thermal induced stress in the preform cone area which may shatter the preform to pieces is also avoided.

The other objects and advantages of the present invention will be apparent from the following description when read in conjunction with the accompanying drawings which are incorporated for the purpose of illustration of present invention and not to limit scope thereof.

### BRIEF DESCRIPTION OF THE INVENTION

Therefore, in accordance with the present invention there is provided an apparatus and a method for preparing a preform cone having desired shape and dimensions, including diameter, wherein the step of heating the preform end to prepare the preform cone before start of step of fiber draw and step of cooling the prepared preform cone to a suitable temperature for safe handling and storage of the prepared preform cone if the preform is required to be stored before start of step of fiber draw are totally avoided, because the presently disclosed apparatus is such which neither requires any heating means for preparation of preform cone nor any cooling means for immediate cooling the prepared preform cone, and hence, the prepared preform cone will have a temperature suitable for its safe handling and/or storage for fiber draw at a later stage, meaning thereby the presently disclosed apparatus and method for preparing the preform cone also avoids possibility of non-uniform cooling or immediate cooling or abrupt cooling, and hence, avoids possibility of formation of physical defects and stress in the preform cone which otherwise may form if the prepared preform cone is non-uniformly cooled or immediately cooled or abruptly cooled, and also overcomes certain limitations, drawbacks and disadvantages of the prior art as described herein.

Accordingly, the present invention relates to an apparatus for preparing a preform cone having desired shape and dimensions, including diameter, comprising a box type structure provided with:
a coupling means suitably provided on the inner side of upper face for holding one end of the core rod of the soot preform which is required to be subjected to step of cone preparation;
a grinding or cutting means suitably provided on the inner side of the lower face for grinding or cutting the preform end to produce preform cone of desired shape and dimensions including diameter;
a suction means suitably provided on inner side of one of the faces of the box type structure for immediate removal of soot particles produced during grinding or cutting of the preform end to produce the preform cone of desired shape and dimensions; and
an adjustable rotating means suitably connectable to grinding or cutting means to have simultaneous control of rotation speed and position of the grinding or cutting means with respect to preform end wherein the preform cone is being prepared.

In one embodiment, the present invention also relates to a process for preparation of preform cone employing the apparatus of the present invention to have preform cone of desired shape and dimensions, including desired diameter.

The other embodiments and advantages of the present will be apparent from the following description when read in conjunction with the accompanying drawings which are incorporated for illustration of preferred embodiments of the present invention and are not intended to limit scope thereof.

### BRIEF DESCRIPTION OF THE ACCOMPANYING DRAWINGS

FIG. 1 illustrates a schematic representation of deposition process over a mandrel to produce a soot porous body.

FIG. 2 illustrates a schematic representation of hollow soot porous body having centerline therethrough after removal of mandrel from the soot porous body.

FIG. 3 illustrates a schematic cross-sectional view of hollow soot porous body having centerline therethrough after removal of mandrel from the soot porous body.

FIG. 4 illustrates a schematic representation of hollow soot porous body in side the sintering furnace after removal of mandrel from the soot porous body.

FIG. 5 illustrates a hollow soot porous body having centerline therethrough after removal of mandrel from the soot porous body which is subjected to steps of dehydration, sintering and collapsing to produce a solid glass preform.

FIG. 6 illustrates a schematic representation of the apparatus for preparing a preform cone in accordance with one embodiment of the present invention.

FIG. 7 illustrates a schematic representation of the apparatus for preparing a preform cone in accordance with another embodiment of the present invention.

FIG. 8 illustrates a schematic representation of the method for preparing a preform cone in accordance with one embodiment of the present invention.

### DETAILED DESCRIPTION AND PREFERRED EMBODIMENTS OF THE INVENTION

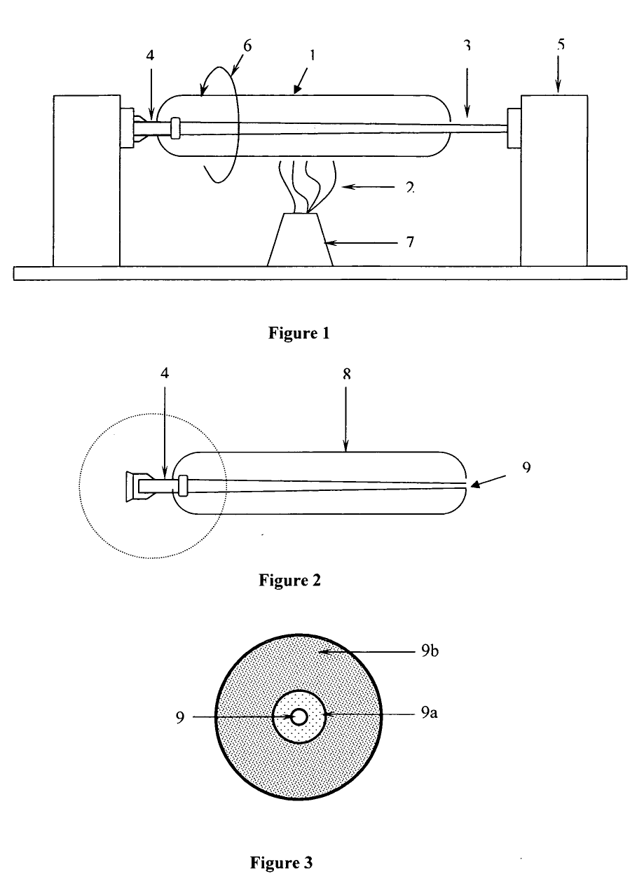

The soot porous body can be prepared by any method known in the art. For example, by atmospheric chemical vapour deposition [ACVD] method. In accordance with a typical process to manufacture a preform, as for example illustrated in accompanying FIG. 1, the preparation of soot porous body 1 comprises the following steps. The glass-forming precursor compounds are oxidized and hydrolyzed to form porous silica based materials 2. The porous silica based materials 2 are deposited on a tapered cylindrical member referred as mandrel 3, which can be any commercially available mandrel with or without any specific preparation, preferably with specific preparation to remove the contaminants therefrom which is provided with a handle rod 4 and fitted on a lathe 5 to form soot porous body 1.

During the step of deposition, the mandrel 3 is rotated in a direction as illustrated by an arrow 6 and also moved along its length with reference to burner 7 to deposit the soot particles 2 on the mandrel 3 for producing soot porous body 1. During the deposition process, the dopant chemicals for example GeCl₄ may also be deposited to form the core of the preform and later the dopant chemicals may be terminated to form clad of the preform. The amount of deposition of the clad region 9b and core region 9a is achieved to have any desired ratio diameter of clad region 9b to the diameter of core region 9a.

After completion of deposition, the soot porous body 1 is removed from lathe 5 along with mandrel 3 and handle rod 4, and the mandrel 3 is removed/detached, during the mandrel removal step, from the soot porous body 1 thereby resulting in formation of a hollow cylindrical soot porous body 8 (herein after referred to as hollow soot porous body) having a centerline 9 therethrough [FIG. 2].

The hollow soot porous body 8 thus formed comprises a core region 9a having a centerline hole 9 and a clad region 9b of the optical fiber preform [FIG. 3], and said core region 9a has refractive index greater than that of the clad region 9b.

After removal/detachment of mandrel 3 a centerline 9 is created inside the soot porous body 1.

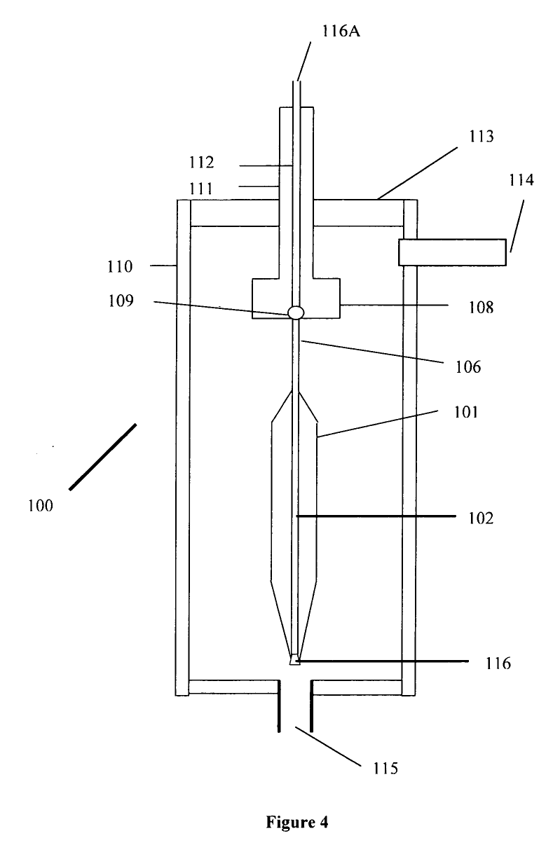

Now referring to accompanying FIG. 4, the prepared hollow soot porous body 101 is transferred to the sintering furnace 100 in order to achieve dehydration, and sintering of the hollow soot porous body 101 to form dehydrated and sintered hollow glass body.

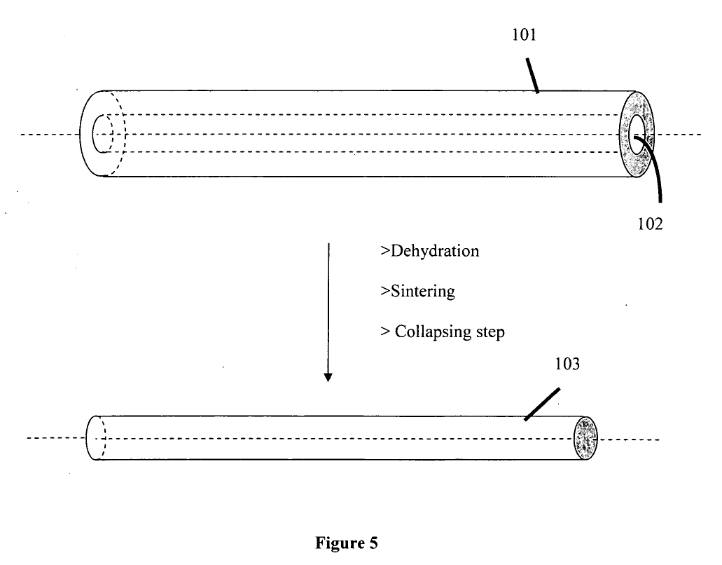

The dehydrated and sintered hollow glass body is subjected to step of collapsing of the centerline 102 to form a solid glass preform 103 [FIG. 5] with or without requiring any step of drilling or grinding or etching of the centerline 9/102 before steps of consolidation and collapsing.

Thus, the prepared hollow soot porous body 101 is dehydrated, sintered and collapsed to convert it into solid glass preform 103.

In one embodiment, the hollow soot porous body 101, one end of which is provided with a plug 116 is inserted inside the furnace 100 with the help of the handle rod 106. The driving mechanism (not shown) facilitates lowering of the hollow soot porous body 101 into the furnace 100. The furnace 100 comprises a glass muffle tube 110 having a diameter sufficient to accommodate the preform 101 and to adequately provide the environment necessary for dehydration, sintering and collapsing. The muffle tube 110 is heated to temperatures necessary for dehydration and simultaneous sintering and collapsing process steps with the heating means (not shown) that is fitted to the sintering furnace 100.

The heating means selected may be suitable to create three heat zones inside the muffle tube 110 over a length. A thermocouple (not shown) provided in the furnace 100 measures the temperature of the hot zones inside the furnace created by the heating means, and the data measurement is fed to the temperature controller (not shown) that controls the temperature inside the muffle tube 110.

The furnace 100 is provided with an inlet port 115 located suitably on the furnace, preferably near the bottom of the muffle tube 110 for supplying desired gases in the furnace. The top end of the muffle tube 110 is closed with the lid 113 to achieve the preferred temperature profile inside the muffle tube 110 and to maintain the same during the dehydration, and simultaneous sintering and collapsing process steps, and to avoid leakage of gases from the muffle tube 110 to the outside environment. A suction port 114 is suitably provided near the top of muffle tube 110 to facilitate evacuation of the gases from the muffle tube 110 as and when required or on completion of the process.

In accordance with the known art methods, the solid glass preform, which may also be referred as mother preform, produced is subjected, in a conventional manner, to a step of reducing the diameter to form a core rod having reduced diameter, which is subjected, in a conventional manner, to a step of overcladding to form a soot preform comprising soot porous body having core rod [herein referred as soot preform]; which is subjected, in a conventional manner, to a sintering step to form a sintered preform, which may also be referred as daughter preform, which is subjected to a step of fiber draw to draw the fiber.

In accordance with the known art, the fiber may be drawn either from the mother preform or from the daughter preform, and hence, the preform cone can be prepared either at the mother preform or at the daughter preform stage, which as described herein above, essentially require performing a step of heating to a very high temperature of the order of about 2000° C. which, if the preform [mother or daughter preform] has to be stored, is followed by highly controlled step of cooling the prepared preform cone. These steps of heating followed by controlled cooling are known to suffer from various disadvantages, drawbacks and limitations, as elaborated hereinabove.

The inventors have surprisingly observed that the cone can also be prepared at the soot preform comprising soot porous body having core rod stage. The cone preparation at the soot preform stage has been surprisingly observed to be feasible by cutting or grinding the soot porous body of the soot preform by a grinding or cutting means which has been found to be possible without requiring step of heating, which, if the soot preform having prepared cone has to be stored, is not required to have highly controlled step of cooling meaning thereby the cone preparation at soot preform stage has been found to be possible with out requiring step of heating to a very high temperature of the order of about 2000° C. and highly controlled step of cooling the preform cone, and hence, it has been found that the preform cone preparation at the soot preform stage does not suffer from known disadvantages, drawbacks and limitations of the prior art as elaborated hereinabove.

It may be noted that for the ease of understanding the soot preform comprising soot porous body having core rod is referred as “soot preform” which may not be confused with “mother preform” or “daughter preform”, and the end of the soot preform where cone is being prepared is referred as “preform end” and the cone prepared on one of end of the soot preform is referred as “preform cone”.

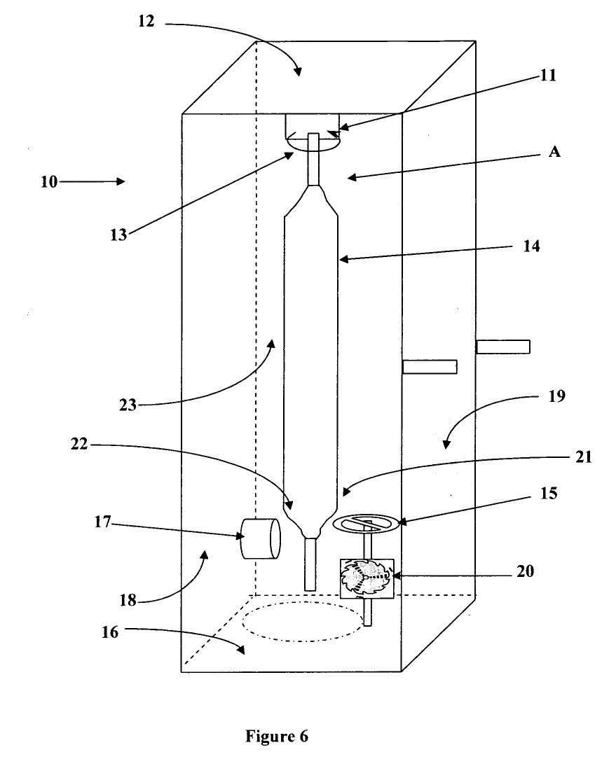

Now referring to accompanying FIG. 6, the present invention provides an apparatus for preparing a preform cone having desired shape and dimensions, including diameter, comprising a box type structure 10 provided with:
a coupling means 11 suitably provided on the inner side of upper face 12 for holding one end of the core rod 13 of the soot preform 14 which is required to be subjected to step of cone preparation;
a grinding or cutting means 15 suitably provided on the inner side of one of the faces of the box type structure 10 for grinding or cutting the preform end 21 to produce preform cone 22 of desired shape and dimensions including diameter;
a suction means 17 suitably provided on inner side of one of the faces of the box type structure 10 for immediate removal of soot particles produced during grinding or cutting of the preform end 21 to produce the preform cone 22 of desired shape and dimensions including diameter; and
an adjustable rotating means 20 suitably connectable to grinding or cutting means 15 to have simultaneous control of rotation speed and position of the grinding or cutting means 15 with respect to preform end 21 wherein the preform cone 22 is being prepared

In accordance with one of the preferred embodiments of the present invention, the grinding or cutting means 15 is preferably provided on the inner side of the lower face 16 for grinding or cutting the preform end 21 to produce preform cone 22 of desired shape and dimensions including diameter.

In accordance with one of the preferred embodiments of the present invention, the grinding or cutting means 15 is capable of moving in all directions including right and left, and up and down, too and fro, and circular directions to achieve complete and smooth cutting or grinding of the preform end 21 to produce the preform cone 22 of desired shape and dimensions, including diameter.

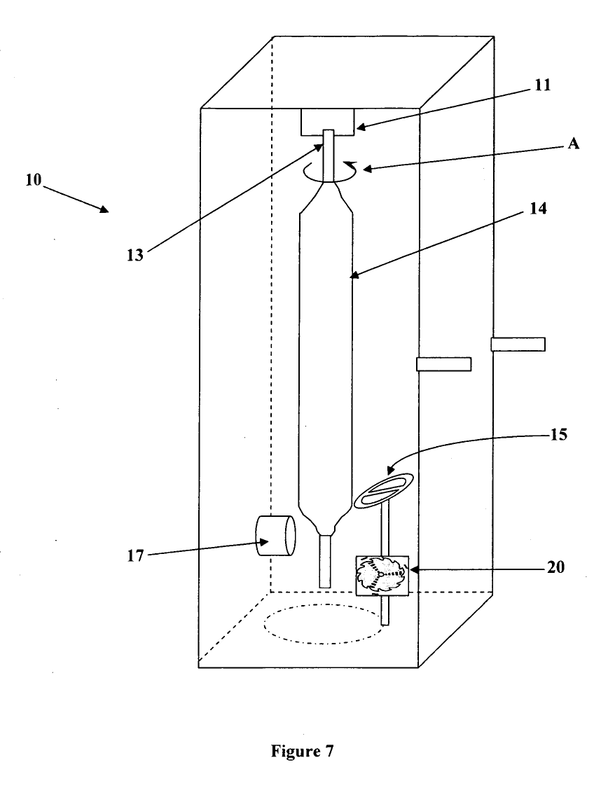

In accordance with one of the preferred embodiments of the present invention, the grinding or cutting means 15 is provided in the inclined position [FIG. 7]. The grinding or cutting means 15 is provided in inclined position at about 40-55 degree angle to achieve smooth grinding or cutting of the preform end.

In accordance with one of the preferred embodiments of the present invention, the suction means 17 is provided on inner side of left face 18 or right face 19 of the box type structure 10 for immediate removal of soot particles produced during grinding or cutting of the preform end 21 to produce the preform cone 22 of desired shape and dimensions, including diameter.

In accordance with one of the preferred embodiments of the present invention, the suction means 17 is made of flexible material so as to achieve its adjustment with respect to position of the preform end thereby achieving immediate and easy removal of soot particles produced during grinding or cutting of the preform end to produce the preform cone of desired shape and dimensions including diameter.

The position of suction means 17, in accordance with one of the preferred embodiments of this invention is adjustable with respect to position of the preform end so as to have closure position with respect to the preform end thereby achieving immediate and easy removal of soot particles produced during grinding or cutting of the preform end to produce the preform cone of desired shape and dimensions including diameter.

In accordance with preferred embodiment of the present invention, the suction means 17 is made of flexible material and is adjustable with respect to position of the preform end 21 so as to achieve its adjustment having closure position with respect to position of the preform end thereby achieving immediate and easy removal of soot particles produced during grinding or cutting of the preform end to produce the preform cone of desired shape and dimensions including diameter.

In accordance with preferred embodiment of the present invention, the adjustable rotating means 20 connectable with the grinding or cutting means 15 is adjustable on the respective face so as to have full control of grinding or cutting operation of the preform end 21 by simultaneously controlling rotation and position of the grinding or cutting means 15 with respect to the preform end 21 wherein the preform cone 22 is being prepared in accordance with method of the present invention.

In accordance with another preferred embodiment of the present invention, the adjustable rotating means 20 is provided either on lower face 16 or on rear face 23 or on side face 18 or 19 to have simultaneous control of rotation and position of the grinding or cutting means 15 with respect to the preform end 21 wherein the preform cone 22 is being prepared in accordance with method of the present invention.

In accordance with more preferred embodiment of the present invention, the adjustable rotating means 20 with grinding or cutting means 15 is provided on the face of the box type structure 10 in a manner to have it opposite to the position of suction means 17, and such constructional feature has been observed to provide not only simultaneous control of rotation and position of the grinding or cutting means 15 with respect to the preform end 21 wherein the preform cone 22 is being prepared in accordance with method of the present invention, but has also been observed to provide ease of immediate removal of soot particles produced during the grinding or cutting of the preform end to produce preform cone.

Accordingly, if suction means 17 is provided on face 18, then the adjustable rotating means 19 with grinding or cutting means 15 is provided on face 19, and it is immaterial whether face 18 is left or right face.

In accordance with preferred embodiment of the present invention, the suction means 17 is provided on the face of the box type structure 10 in a manner to have it opposite to the position of grinding or cutting means 15, and such constructional feature has been observed to result in immediate and smooth removal of soot particles produced during the grinding or cutting of preform end 21 to produce the preform cone 22 of desired shape and dimensions, including diameter.

In accordance with its most preferred embodiment, the present invention provides an apparatus for preparing a preform cone having desired shape and dimensions, including diameter, comprising a box type structure 10 provided with:
a coupling means 11 suitably provided on the inner side of upper face 12 for holding one end of the core rod 13 of the soot preform 14 which is required to be subjected to step of cone preparation;
a grinding or cutting means 15 suitably provided on the inner side of the lower face 16 of the box type structure 10 and capable of moving in all directions including right and left, and up and down, too and fro, and circular directions for achieving complete and smooth grinding or cutting of the preform end 21 for producing preform cone 22 of desired shape and dimensions including diameter;
a suction means 17 suitably provided on the face of the box type structure 10 to have it opposite to the position of grinding or cutting means 15, and made up of flexible material and adjustable with respect to position of the preform end 21 so as to achieve its adjustment to have closure position with respect to position of the preform end 21 for achieving immediate, smooth and easy removal of soot particles produced during grinding or cutting of the preform end 21 for producing the preform cone 22 of desired shape and dimensions including diameter; and
an adjustable rotating means 20 suitably connectable to grinding or cutting means 15, and provided on the face of box type structure 10 to have it opposite to the position of the suction means 17 for achieving simultaneous control of rotation speed and position of the grinding or cutting means 15 with respect to the preform end 21 wherein the preform cone 22 is being prepared and to have ease of immediate and smooth removal of soot particles produced during the grinding or cutting of the preform end 21.

In one embodiment, the present invention also provides a process for preparation of preform cone employing the apparatus of the present invention to have preform cone of desired shape and dimensions, including desired diameter.

Accordingly, the present invention relates to a process for preparation of preform cone of desired shape and dimensions including diameter characterized in that the preform cone is prepared at the soot preform stage without the step of heating to a very high temperature, for example of the order of about 2000° C. and without a step of cooling, preferably a step of controlled cooling of the preform cone thus prepared wherein the soot preform comprises soot porous body having core rod.

In accordance with present invention the soot preform comprising soot porous body having core rod can be prepared by any conventional method, for example the ACVD method as described herein.

Accordingly, the present invention in one of the preferred embodiments relates to a process for preparation of preform cone at soot preform stage, wherein the soot preform comprises soot porous body having core rod and the process comprises the steps of:—
preparing the mandrel;
placing the mandrel over a lathe;
depositing soot particles on the mandrel to prepare a soot porous body;
removing the mandrel to form hollow soot porous body having capillary therethrough;
dehydrating the hollow soot porous body to form dehydrated soot porous body;
performing sintering step on dehydrated soot porous body to form sintered glass body;
performing collapsing step to collapse the capillary of the sintered glass body to form solid glass preform;
performing the step of reducing the diameter of the solid glass preform to form a core rod having reduced diameter;
overcladding the core rod having reduced diameter to form soot preform comprising soot porous body having core rod;
   characterized by
performing step of cone preparation on one end of the soot preform to have a preform cone of desired shape and dimensions, including diameter by grinding or cutting the soot at one end of the soot preform by a grinding or cutting means;
performing sintering step on the soot preform having prepared preform cone to form a sintered preform; and
performing fiber draw step on the sintered preform to draw the fiber therefrom.

In accordance with present invention the step of cone preparation on one end of the soot preform to have a preform cone of desired shape and dimensions including diameter is performed by grinding or cutting the soot at one end of the soot preform by employing a grinding or cutting means of the cone preparation apparatus of the present invention.

In accordance with preferred embodiment of the present the soot preform having prepared preform cone is stored and/or transported to another site before performing the sintering step to form a sintered preform.

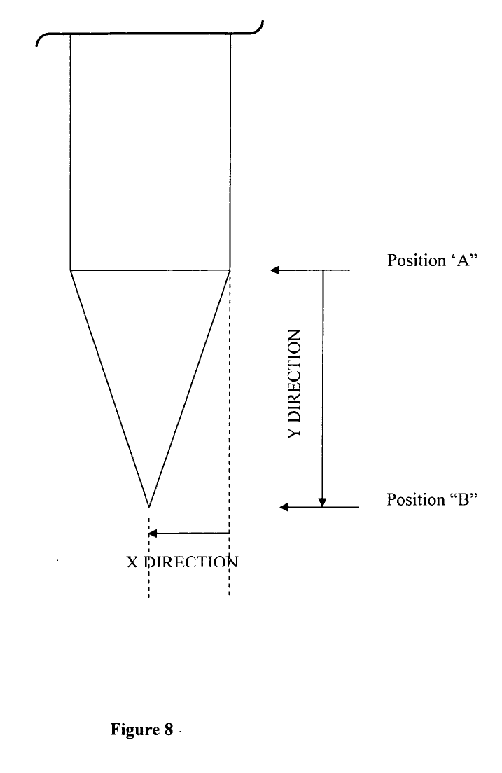

In accordance with preferred embodiment of the present invention, the grinding or cutting means preferably moves in Y direction [FIG. 8] from the predetermined position “A” to position “B”, which is end of the soot preform and while moving in Y direction it also moves towards the center of the soot preform in X direction.

In accordance with one of the preferred embodiments of the present invention, the soot preform is rotated during the step of cone preparation, preferably at a rotation speed of about 3 to 5 rotation per minute. It has been found that if rotation speed is increased beyond the speed of 5 rotation per minute the soot peels off in the soot preform.

In accordance with one of the preferred embodiments of the present invention, the grinding or cutting means rotates along its own axis preferably at about 800 to 1000 revolutions per minute.

In accordance with one of the preferred embodiments of the present invention, the grinding or cutting means moves in Y direction preferably at a speed of less than or equal to about 5 mm per minute. It has been found that if speed in Y direction is increased beyond the speed of 5 mm per minute the preform cone may have spirals [non-uniform cutting or grinding] therein.

In accordance with one of the preferred embodiments of the present invention, the grinding or cutting means moves in X direction preferably at a speed varying from about 0.5 mm per minute to about 3 mm per minutes. It has been found that speed in X direction can be determined based on the speed in Y direction and based on the desired shape of the preform cone.

In accordance with present invention, if preform cone of triangular shape is required, then the grinding or cutting means is moved in X direction at a constant speed, and if preform cone of curved shape is required, then the grinding or cutting means is moved in X direction at variable speed.

In accordance with one of the preferred embodiments of the present invention, the soot preform remains stationary and the grinding or cutting means rotates around the soot preform. In accordance with this embodiment, the grinding or cutting means preferably rotates at a speed of less than or equal to about 5 mm per minute.

It has been surprisingly observed that when grinding or cutting means simultaneously moves in Y direction at a speed of less than or equal to about 5 mm per minute and in X direction at a speed varying from about 0.5 mm per minute to about 3 mm per minutes simultaneously with rotation of the soot preform at a rotation speed of about 3 to 5 rotation per minute, the preform cone of desired shape and dimensions, including diameter has been easily and conveniently obtained by employing present apparatus and method without a step of heating of the preform end, and hence, without a step of controlled cooling of the prepared preform cone.

Accordingly, the presently disclosed apparatus and method for cone preparation at soot preform stage totally avoid or eliminate step of heating of preform end for preparation of preform cone meaning thereby overcome all associated disadvantages, drawbacks and limitations of the step of heating the preform end, and hence avoid or eliminate step of highly controlled cooling of the preform end after preparation of preform cone, and also address the problems encountered during the process step of cone preparation just before the process step of fiber draw.

Further, with the adjustable grinding or cutting means of the presently disclosed apparatus, it has been possible to produce preform cone having precisely controlled cone of desired shape and dimensions, including desired diameter which is suitable for start of fiber draw without wastage of preform.

The preform cone prepared by employing present apparatus and method has been observed to be free from formation of any defects thereby avoiding possibility of breakage, and hence, possibility of loss of fiber length during start of fiber draw step. Accordingly, the present apparatus and method for preparation of cone result in exorbitant power and energy savings.

It is apparent from the present description that preparation of preform cone by employing present apparatus and method is not only easy and convenient, but also highly time saving meaning thereby the overall process for cone preparation is not only easy, convenient and controlled, but also highly productive and economical for commercial applications.

It is also apparent from the foregoing that the present apparatus for preparation of preform cone does not require any complicated, sophisticated, expensive and specially built furnace, for example, hydroxy flame burners, graphite resistance or induction furnace, plasma heating means, power full lasers for heating the preform end, and any complicated, sophisticated, expensive and specially built containers or vessels with specially built cooling means for controlled cooling of prepared preform cone. Accordingly, the present method for preparation of preform cone does not require any step of heating the preform end and controlled cooling of prepared preform cone. Therefore, the present apparatus and method for preparation of preform cone have been found to be further economical for commercial purposes.

As the present apparatus for preparation of preform cone does not require hydroxyl flame burners, it avoids possibility of increase of hydroxyl contents of the preform during the step of cone preparation, and hence a preform produced has been found to have reduced transmission loss, particularly at about 1380 nm wavelength band and accordingly the preform produced has been found to be suitable for CDWM (16 Channels) applications.

As the present apparatus for preparation of preform cone does not require graphite resistance or induction furnace, it avoids possibility of contamination of soot preform having desired preform cone with oxidation products, for example ash, graphite particles etc., thereby possibility of transmission loss and poor strength of the soot preform produced is avoided.

As the present apparatus for preparation of preform cone does not require high power lasers, such as carbon dioxide lasers for preparation of preform cone, it avoids losses on account of consumption of high power required to generate required high temperature meaning thereby the overall production cost is reduced, and possibility of thermal induced stress in the preform cone area which may shatter the preform to pieces is also avoided.

As the present method does not require a step of cooling the prepared preform cone, it has been found to avoid possibility of any non-uniform cooling or immediate cooling or abrupt cooling, and hence, possibility of formation of physical defects and stress in the preform cone.

Further, the fiber produced from the preform having preform cone of desired shape produced by employing present apparatus and method for preparation of preform cone has been found to be not only having reduced transmission loss, but also having desired other optical parameters, for example, desired polarization mode dispersion, cutoff wavelength etc.

It is apparent from the foregoing description that the presently disclosed apparatus and method for preparation of preform cone have overcome disadvantages, limitations and drawbacks of the prior art.

It may be noted that various terms, for example box type structure, coupling means, grinding or cutting means, suction means, adjustable rotating means, mandrel, soot porous body, hollow soot porous body, capillary, dehydrated soot porous body, sintered glass body, solid glass preform, core rod having reduced diameter, soot porous body having core rod, core rod, soot preform, preform end, preform cone, sintered core rod etc. as employed herein are merely intended to illustrate the present invention and are not intended to restrict scope of the present invention. It is obvious for the persons skilled in the art that alternative terms may also be employed to describe the present apparatus and method without deviating from the intended scope of the present invention.

It may also be noted that the presently disclosed apparatus and method have been described with reference to ACVD method. However, the present apparatus and method are suitable even for other alternative methods known for producing soot preform.

1. An apparatus for preparing a preform cone having desired shape and dimensions, including diameter, comprising a box type structure provided with:
a coupling means suitably provided on the inner side of upper face for holding one end of the core rod of the soot preform which is required to be subjected to step of cone preparation;
a grinding or cutting means suitably provided on the inner side of one of the faces of the box type structure for grinding or cutting the preform end to produce preform cone of desired shape and dimensions including diameter;
a suction means suitably provided on inner side of one of the faces of the box type structure for immediate removal of soot particles produced during grinding or cutting of the preform end to produce the preform cone of desired shape and dimensions; and
an adjustable rotating means suitably connectable to grinding or cutting means to have simultaneous control of rotation speed and position of the grinding or cutting means with respect to preform end wherein the preform cone is being prepared.

2. An apparatus as claimed in claim 1, wherein said grinding or cutting means is provided on the inner side of the lower face of the box type structure.

3. An apparatus as claimed in claim 1, wherein said grinding or cutting means is capable of moving in all directions including right and left, and up and down, to and fro, and circular directions.

4. An apparatus as claimed in claim 1, wherein said grinding or cutting means is provided in the inclined position.

5. An apparatus as claimed in claim 1, wherein said suction means is provided on inner side of left face or right face of the box type structure for achieving immediate removal of soot particles.

6. An apparatus as claimed in claim 5, wherein said suction means is made of flexible material.

7. An apparatus as claimed in claim 5, wherein said suction means is adjustable with respect to position of the preform end.

8. An apparatus as claimed in claim 5, wherein said suction means is made of flexible material and is adjustable with respect to position of the preform end.

9. An apparatus as claimed in claim 1, wherein said adjustable rotating means is adjustable on the respective face to have full control of grinding or cutting operation of the preform end.

10. An apparatus as claimed in claim 9, wherein said adjustable rotating means is provided either on lower face or on rear face or on one of the side faces of the box type structure to have simultaneous control of rotation and position of the grinding or cutting means with respect to the preform end.

11. An apparatus as claimed in claim 9, wherein said adjustable rotating means with grinding or cutting means is provided on the face of the box type structure in a manner to have it opposite to the position of suction means.

12. An apparatus as claimed in claim 1, wherein said suction means is provided on the face of the box type structure in a manner to have it opposite to the position of said grinding or cutting means.

13. An apparatus as claimed in claim 1, which does not require complicated, sophisticated, expensive and specially built furnace including hydroxy flame burners, graphite resistance or induction furnace, plasma heating means, power full lasers for heating the preform end for preparation of the preform cone.

14. An apparatus as claimed in claim 1, which does not require complicated, sophisticated, expensive and specially built containers or vessels with specially built cooling means for controlled cooling of prepared preform cone.

15. An apparatus for preparing a preform cone having desired shape and dimensions, including diameter, comprising a box type structure provided with:
a coupling means suitably provided on the inner side of upper face for holding one end of the core rod of the soot preform which is required to be subjected to step of cone preparation;
a grinding or cutting means suitably provided on the inner side of the lower face of the box type structure and capable of moving in all directions including right and left, and up and down, to and fro, and circular directions for achieving complete and smooth grinding or cutting of the preform end for producing preform cone of desired shape and dimensions including diameter;
a suction means suitably provided on the face of the box type structure to have it opposite to the position of grinding or cutting means, and made up of flexible material and adjustable with respect to position of the preform end so as to achieve its adjustment to have closure position with respect to position of the preform end for achieving immediate, smooth and easy removal of soot particles produced during grinding or cutting of the preform end for producing the preform cone of desired shape and dimensions including diameter; and
an adjustable rotating means suitably connectable to grinding or cutting means, and provided on the face of box type structure to have it opposite to the position of the suction means for achieving simultaneous control of rotation speed and position of the grinding or cutting means with respect to the preform end wherein the preform cone is being prepared and to have ease of immediate and smooth removal of soot particles produced during the grinding or cutting of the preform end.

16. A process for preparation of preform cone of desired shape and dimensions including diameter characterized in that the preform cone is prepared at the soot preform stage without the step of heating to a very high temperature and without a step of cooling of the preform cone thus prepared, wherein the soot preform comprises soot porous body having core rod.

17. A process as claimed in claim 16, wherein step of cone preparation on one end of the soot preform to have a preform cone of desired shape and dimensions, including diameter is performed by grinding or cutting the soot at one end of the soot preform by a grinding or cutting means.

18. A process as claimed in claim 17, wherein said soot preform having prepared preform cone prepared in accordance with process of claim 16 is stored and/or transported to another site before performing the sintering step to form a sintered core rod.

19. A process as claimed in claim 17, wherein said grinding or cutting means preferably moves in Y direction from the predetermined position “A” to position “B” and while moving in Y direction it also moves towards the center of the soot preform in X direction.

20. A process as claimed in claim 17, wherein said soot preform is rotated during the step of cone preparation.

21. A process as claimed in claim 20, wherein said soot preform is rotated at a rotation speed of about 3 to about 5 rotation per minute.

22. A process as claimed in claim 17, wherein said grinding or cutting means rotates along its own axis at about 800 to about 1000 revolutions per minute.

23. A process as claimed in claim 19, wherein said grinding or cutting means moves in Y direction at a speed of less than or equal to about 5 mm per minute.

24. A process as claimed in claim 19, wherein said grinding or cutting means moves in X direction at a speed varying from about 0.5 mm per minute to about 3 mm per minutes.

25. A process as claimed in claim 24, wherein said grinding or cutting means moves in X direction at a constant speed to have preform cone of triangular shape.

26. A process as claimed in claim 24, wherein said grinding or cutting means moves in X direction at a variable speed to have preform cone of curved shape.

27. A process as claimed in claim 17, wherein said soot preform remains stationary and the grinding or cutting means rotates around the soot preform.

28. A process as claimed in claim 27, wherein said grinding or cutting means rotates at a speed of less than or equal to about 5 mm per minute.

29. A process as claimed in claim 17, wherein said grinding or cutting means simultaneously moves in Y direction at a speed of less than or equal to about 5 mm per minute and in X direction at a speed varying from about 0.5 mm per minute to about 3 mm per minutes simultaneously with rotation of the soot preform at a rotation speed of about 3 to 5 rotation per minute.

30. A soot preform as and when prepared by a process as claimed in claim 16, wherein said soot preform has a preform cone of desired shape and dimensions, including diameter.

31. An optical fiber as and when prepared from soot preform as claimed in claim 30, wherein said optical fiber has reduced transmission loss, particularly at about 1380 nm wavelength band and is suitable for CDWM (16 Channels) applications.
